(19) United States
(12) Patent Application Publication
(10) Pub. No.: US 2007/0040880 A1
(43) Pub. Date: Feb. 22, 2007

(54) Inkjet ink

(76) Inventors: Christian Jackson, Wilmington, DE (US); William Thomas Hall, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/472,710

(22) Filed: Jun. 22, 2006

Related U.S. Application Data
(60) Provisional application No. 60/710,318, filed on Aug. 22, 2005.

(51) Int. Cl. G01D 11/00; C09D 11/02

(52) U.S. Cl. 347/100; 106/31.86; 106/31.78; 106/31.87; 106/31.43; 106/31.68

(57) ABSTRACT

The present invention pertains to inkjet ink with long latency and, more particularly, to an aqueous inkjet ink comprising a self-dispersing pigment and certain water soluble vehicle components which, in combination, provide long latency.

### CROSS-REFERENCE TO RELATED APPLICATION

This application claims priority under 35 U.S.C. §119 from U.S. Provisional Application Ser. No. 60/710,318, filed Aug. 22, 2005.

### BACKGROUND OF THE INVENTION

The present invention pertains to inkjet ink with long latency and, more particularly, to an aqueous inkjet ink comprising a self-dispersing pigment and certain water soluble vehicle components which, in combination, provide long latency.

Inkjet printing is a non-impact printing process in which droplets of ink are deposited on a substrate, such as paper, to form the desired image. The droplets are ejected from a printhead in response to electrical signals generated by a microprocessor. Inkjet printers offer low cost, high quality printing and have become a popular alternative to other types of printers.

An ink-jet ink is characterized by a number of necessary properties, including color, jettability, decap time (latency), drying time and shelf-life, among others. There is, however, often a tradeoff between these properties because improving one property can result in the deterioration of another property.

The decap time of the ink is the amount of time a printhead can be left uncapped and idle and still fire a drop properly—that is to say without misdirection, loss of color or unacceptable decrease of velocity. Decap is sometimes referred to in the art as “latency” and these two terms will be used interchangeably.

Because not all the nozzles of the printhead print all the time, a printer service routine requires the idle nozzles to discharge (“spit”) on a regular basis into the waste container (“spittoon”) to avoid printing defects. It is desirable, however, to service the printhead as infrequently as possible as it is wasteful of ink and slows print speeds. To reduce need for servicing, an ink will preferably have a long decap time.

Contributing to decap problems is the trend for printheads to fire smaller drops to increase image resolution. The increased surface area to volume to the smaller drops allows faster evaporation of volatile vehicle components at the nozzle face and thereby tends to decrease decap time.

Both dyes and pigments have been used as colorants for inkjet inks and both have certain advantages. Pigment inks are advantageous because they tend to provide more water-fast and light-fast images than dye inks. Also, with regard to black inks, carbon black pigment can provide much higher optical density than any available dye colorant.

Pigments, in order to be used in inks, must be stabilized to dispersion in the ink vehicle. Stabilization of the pigment can be accomplished by use of separate dispersing agents, such as polymeric dispersants or surfactants. Alternatively, a pigment surface can be modified to chemically attach dispersibility-imparting groups and thereby form a so-called “self-dispersible” or “self-dispersing” pigment (hereafter “SDP(s)”) which is stable to dispersion without separate dispersant.

SDPs are often advantageous over traditional dispersant-stabilized pigments from the standpoint of greater stability and lower viscosity at the same pigment loading. This can provide greater formulation latitude in final ink.

U.S. Pat. No. 6,069,190 pertains to SDP ink compositions with improved latency. U.S. Pat. No. 6,572,227 and U.S. Pat. No. 6,153,001 discloses various SDP ink compositions, including ones containing sulfolane at levels ranging between 5 and 10 weight % and urea at levels of 4 or 5 weight %.

Although current SDP ink compositions are being successfully jetted, there is still a need in the art for, and it is an object of this invention to provide, inks with longer decap times that still retain other beneficial print properties.

### SUMMARY OF THE INVENTION

In accord with an objective of this invention, it was found that an aqueous inkjet ink comprising SDP in combination with a particular set of humectants can provide surprisingly long latency.

Thus, in one aspect, the present invention pertains to an aqueous ink-jet ink comprising a colorant stably dispersed in an aqueous vehicle, wherein:
(a) said colorant comprises a self-dispersed pigment; and
(b) said aqueous vehicle comprises water, a first humectant, a second humectant and a third humectant wherein
   (i) said first humectant is one or a combination of a water-soluble organic molecule having at least two hydroxyl groups, and a carbon/oxygen ratio of two or less;
   ii) said second humectant is selected from the group consisting of 2-pyrrolidone, sulfolane, tetramethylene sulfoxide, gamma-butyrolactone, 1,3-dimethyl-2-imidazolidinone and mixtures thereof; and
   (iii) said third humectant is urea.

Sulfolane, if present, is limited to less than 5 wt %. If not stated otherwise, reference to wt % in the context of the present invention is based on the total weight of the ink.

Examples of preferred members of the group of first humectants include glycerol, ethylene glycol, diethylene glycol, triethylene glycol, tetraethylene glycol, propylene glycol, saccharides and saccharide derivatives.

In accordance with another aspect of the present invention, there is provided an inkjet ink set comprising at least two differently colored inks, wherein at least one of the inks is an inkjet ink as set forth above. Preferably, at least one of the inks is an inkjet ink as set forth above wherein the self-dispersing pigment is a self-dispersing black pigment.

In yet another aspect of the present invention, there is provided a method for inkjet printing onto a substrate, comprising the steps of:

(a) providing an inkjet printer that is responsive to digital data signals;

(b) loading the printer with a substrate to be printed;

(c) loading the printer with an ink as set forth above and described in further detail below, or an inkjet ink set as set forth above and described in further detail below; and

(d) printing onto the substrate using the ink or inkjet ink set in response to the digital data signals.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

Aqueous Vehicle

The ink vehicle is the liquid carrier (or medium) for the colorant(s) and optional additives. The term “aqueous vehicle” refers to a vehicle comprised of water and one or more organic, water-soluble vehicle components commonly referred to as co-solvents or humectants. Sometimes in the art, when a co-solvent can assist in the penetration and drying of an ink on a printed substrate, it is referred to as a penetrant.

According to the present invention, the aqueous vehicle comprises at least three humectants.

The first humectant is one or a combination of a water-soluble organic molecules having at least two hydroxyl (alcohol) groups and a carbon/oxygen ratio of two or less. Preferably, the first humectant has a carbon/oxygen ratio of less than two, and more preferably less than 1.5. Also, the molecular weight is preferably less than about 600 Daltons, more preferably less than about 350 Daltons.

Preferably, the first humectant is substantially neutral (neither acidic nor basic, nor a salt thereof) and does not contain, for example, carboxylic acid groups.

In a preferred embodiment, the first humectant is comprised of only carbon, hydrogen and oxygen. Specific preferred first humectants include glycerol, ethylene glycol, diethylene glycol, triethylene glycol, tetraethylene glycol, saccharides and saccharide derivatives, propylene glycol, and any combination thereof.

Saccharides are, for example, monosaccharides and disaccharides, including glucose, mannose, fructose, ribose, xylose, arabinose, galactose, maltose, cellobiose, lactose, sucrose, trehalose and maltotriose. Saccharide derivatives such as sugar alcohols are also useful. Sugar-alcohols, represented by the general formula
HOCH₂(CHOH)ₙCH₂OH
in which n is an integer of 2 to 5, include, for example, threitol, erythritol, arabitol, ribitol, xylitol, lyxitol, sorbitol, mannitol, iditol, gulcitol, talitol, galactitol, allitol, altritol, maltitol, isomaltitol, lactitol and turanitol.

A summary of hydroxyl (alcohol) groups, and carbon/oxygen ratio content of various molecules is given in the following table.

| | | Number | | | |
|---|---|---|---|---|---|
| | Number of | of | Number of | C/O | Molecular |
| First Humectant | hydroxyls | carbons | oxygens | ratio | weight |
| Ethylene glycol | 2 | 2 | 2 | 1 | 62 |
| Propylene glycol | 2 | 3 | 2 | 1.5 | 76 |
| Diethylene glycol | 2 | 4 | 3 | 1.33 | 106 |
| Triethylene glycol | 2 | 6 | 4 | 1.5 | 150 |
| Glycerol | 3 | 3 | 3 | 1 | 92 |
| 1,2,6-hexanetriol | 3 | 6 | 3 | 2 | 134 |
| 1,5-pentanediol | 2 | 5 | 2 | 2.5 | 104 |
| Trimethylolpropane | 3 | 6 | 3 | 2 | 134 |
| Diethylene glycol | 1 | 5 | 3 | 1.67 | 120 |
| methyl ether | | | | | |
| Xylose | 4 | 5 | 5 | 1 | 150 |
| Fructose | 5 | 6 | 6 | 1 | 180 |

As can be seen, all of the above qualify as first humectants in the context of the present invention except for 1,5-pentanediol (C/O ratio of 2.5) and diethylene glycol methyl ether (one hydroxyl group).

The second humectant is one or a combination of 2-pyrrolidone, sulfolane (also known as tetramethylene sulfone and tetrahydrothiophene-1,1-dioxide), tetramethylene sulfoxide (also known as tetrahydrothiophene oxide), gamma-butyrolactone, 1,3-dimethyl-2-imidazolidinone, and bis-hydroxyethyl-5,5-dimethylhydantoin (also known as di-(2-hydroxyethyl)-5,5-dimethylhydantoin). Sulfolane, when present, is less than 5 wt %, and preferably 4.95 wt % or less, based on the total weight of ink.

The third humectant is urea.

The amount of first humectant present in the final ink (cumulative) is generally between about 0.1 wt % and about 25 wt %, and more typically between about 1 wt % and about 20 wt %. In a preferred embodiment, the first humectant is present in amounts in the range of about 3 wt % to about 15 wt %.

The amount of second humectant present in the final ink (cumulative) is generally between about 0.1 wt % and about 10 wt %, more typically between about 0.5 wt % and about 6 wt %. In a preferred embodiment, the second humectant is present in amounts less than about 6 wt %, and more preferably less than about 5 wt %.

The amount of third humectant present in the final ink is generally between about 0.1 wt % and about 15 wt %, more typically between about 1 wt % and about 10 wt %. In a preferred embodiment, the third humectant is present in an amount between about 2 wt % and about 8 wt %.

The sum of the weight percents of the first, second and third humectants is generally greater than about 6 wt % and typically greater than about 10 wt %, and generally less than about 29 wt % and typically less than about 25 wt %.

The aqueous vehicle may optionally comprise other organic, water-soluble vehicle components. For example, the aqueous vehicle may comprise one or more penetrants, such as a glycol ether and/or 1,2-alkanediol penetrant to make the ink fast(er) drying.

Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediol penetrants include linear 1,2-(C5 to C8)alkanediols and especially 1,2-pentanediol and 1,2-hexanediol.

The aqueous vehicle typically will contain from about 65 wt % to about 94 wt % water with the balance (i.e., from about 35 wt % to about 6 wt %) being organic water-soluble vehicle components such as the humectants. Preferred compositions contain from about 70 wt % to about 90 wt % water, based on the total weight of the aqueous vehicle.

The amount of aqueous vehicle in the ink is typically in the range of from about 70 wt % to about 99.8 wt %, and preferably about 80 wt % to about 99.8 wt %.

Colorant

Pigment colorants, by definition, are substantially insoluble in an ink vehicle and must, therefore, be dispersed. The inks in accordance with the present invention contain a self-dispersing pigment (“SDP(s)”). SDPs are surface modified with dispersibility-imparting groups to allow stable dispersions to be achieved without the use of a separate pigment dispersant (such as a polymeric dispersant). For dispersion in an aqueous vehicle, the SDPs are surface-modified pigments in which one or more hydrophilic groups are attached to the pigment surface. Most typically, the hydrophilic groups are ionizable hydrophilic groups.

The SDPs may be prepared by grafting a functional group or a molecule containing a functional group onto the surface of the pigment, by physical treatment (such as vacuum plasma), or by chemical treatment (for example, oxidation with ozone, hypochlorous acid or the like). A single type or a plurality of types of hydrophilic functional groups may be bonded to one pigment particle.

Most commonly, the ionizable hydrophilic groups are anionic moieties, particularly carboxylate and/or sulfonate groups, which provide the SDP with a negative charge when dispersed in aqueous vehicle. The anionic groups are usually associated with an alkali metal, alkaline earth or amine counterions.

Self-dispersing pigments are described, for example, in U.S. Pat. No. 5,571,311, U.S. Pat. No. 5,609,671, U.S. Pat. No. 5,968,243, U.S. Pat. No. 5,928,419, U.S. Pat. No. 6,323,257, U.S. Pat. No. 5,554,739, U.S. Pat. No. 5,672,198, U.S. Pat. No. 5,698,016, U.S. Pat. No. 5,718,746, U.S. Pat. No. 5,749,950, U.S. Pat. No. 5,803,959, U.S. Pat. No. 5,837,045, U.S. Pat. No. 5,846,307, U.S. Pat. No. 5,895,522, U.S. Pat. No. 5,922,118, U.S. Pat. No. 6,123,759, U.S. Pat. No. 6,221,142, U.S. Pat. No. 6,221,143, U.S. Pat. No. 6,281,267, U.S. Pat. No. 6,329,446, U.S. Pat. No. 6,332,919, U.S. Pat. No. 6,375,317, U.S. Pat. No. 6,287,374, U.S. Pat. No. 6,398,858, U.S. Pat. No. 6,402,825, U.S. Pat. No. 6,468,342, U.S. Pat. No. 6,503,311, U.S. Pat. No. 6,506,245, U.S. Pat. No. 6,852,156. The disclosures of the preceding references are incorporated by reference herein for all purposes as if fully set forth.

Commercial sources of SDPs suitable for use in inkjet applications include Cabot Corporation (Billerica, Mass. USA), Toyo Ink USA LLC (Addison, Ill. USA), Orient Corporation of America (Kenilworth, N.J. USA) and E. I. du Pont de Nemours and Company (Wilmington, Del. USA).

The amount of surface treatment (degree of functionalization) can vary. Advantageous (higher) optical density can be achieved when the degree of functionalization (the amount of hydrophilic groups present on the surface of the SDP per unit surface area) is less than about 3.5 μmoles per square meter of pigment surface (3.5 μmol/m²), more preferably less than about 3.0 μmol/m². Degrees of functionalization of less than about 1.8 μmol/m², and even less than about 1.5 μmol/m², are also suitable and may be preferred for certain specific types of SDPs.

Examples of pigments with coloristic properties useful in inkjet inks include: (cyan) Pigment Blue 15:3 and Pigment Blue 15:4; (magenta) Pigment Red 122 and Pigment Red 202; (yellow) Pigment Yellow 14, Pigment Yellow 74, Pigment Yellow 95, Pigment Yellow 110, Pigment Yellow 114, Pigment Yellow 128 and Pigment Yellow 155; (red) Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; (green) Pigment Green 1, Pigment Green 2, Pigment Green 7 and Pigment Green 36; (blue) Pigment Blue 60, Pigment Violet 3, Pigment Violet 19, Pigment Violet 23, Pigment Violet 32, Pigment Violet 36 and Pigment Violet 38; and (black) carbon black. However, some of these pigments may be not be suitable for preparation as SDP, and choice of colorant may be dictated by compatibility with a given surface treatment method. Colorants are referred to herein by their “C.I.” designation established by Society Dyers and Colourists, Bradford, Yorkshire, UK and published in The Color Index, Third Edition, 1971.

In one preferred embodiment, the hydrophilic functional groups on the SDP are primarily carboxyl groups, or a combination of carboxyl and hydroxyl groups; even more preferably the hydrophilic functional groups on the SDP are directly attached and are primarily carboxyl groups, or a combination of carboxyl and hydroxyl.

Preferred pigments in which the hydrophilic functional group(s) are directly attached may be produced, for example, by a method described in previously incorporated U.S. Pat. No. 6,852,156. Carbon black treated by the method described in this publication has a high surface-active hydrogen content which is neutralized with base to provide very stable dispersions in water. Application of this method to colored pigments is also possible.

The levels of SDP employed in formulated inks are those levels that are typically needed to impart the desired optical density to the printed image. Typically, SDP levels are in the range of about 0.01 wt % to about 10 wt %, and more preferably from about 1 wt % to about 10 wt %.

Other Ingredients (Additives)

Other ingredients, additives, may be formulated into the inkjet ink, to the extent that such other ingredients do not interfere with the stability and jetablity of the ink, which may be readily determined by routine experimentation. Such other ingredients are in a general sense well known in the art.

Commonly, surfactants are added to the ink to adjust surface tension and wetting properties. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont). Surfactants are typically used in amounts up to about 5 wt % and more typically in amounts of no more than 2 wt %. In a preferred embodiment of the present invention, surfactant is present in an amount of between about 0.01 wt % and 0.5 wt %.

Polymers may be added to the ink to improve durability. The polymers can be soluble in the vehicle or dispersed (e.g. “emulsion polymer” or “latex”), and can be ionic or nonionic. Useful classes of polymers include acrylics, styrene-acrylics and polyurethanes.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, materials construction and the shape and size of the nozzle. The inks should have excellent storage stability for long periods so as not clog to a significant extent in an ink jet apparatus. Further, the ink should not corrode parts of the ink jet printing device it comes in contact with, and it should be essentially odorless and non-toxic.

Although not restricted to any particular viscosity range or printhead, the inventive ink is particularly suited to lower viscosity applications. Thus the viscosity (at 25° C.) of the inventive inks can be less than about 7 cps, or less than about 5 cps, and even, advantageously, less than about 3.5 cps. Thermal inkjet actuators rely on instantaneous heating/bubble formation to eject ink drops and this mechanism of drop formation generally requires inks of lower viscosity. As such, the instant inks can be particularly advantages in thermal printheads.

Ink Sets

The ink sets in accordance with the present invention preferably comprise at least two differently colored inks, more preferably at three differently colored inks (such as CMY), and still more preferably at least four differently colored inks (such as CMYK), wherein at least one of the inks is an aqueous inkjet ink as described above.

The other inks of the ink set are preferably also aqueous inks, and may contain dyes, pigments or combinations thereof as the colorant. Such other inks are, in a general sense, well known to those of ordinary skill in the art.

Preferably, at least one of the inks of the ink set is black wherein the self-dispersing pigment is a self-dispersing black pigment.

In addition to the typical CMYK inks, the ink sets in accordance with the present invention may further comprise one or more “gamut-expanding” inks, including different colored inks such as an orange ink, a green ink, a red ink and/or a blue ink, and combinations of full strength and light strengths inks such as light cyan and light magenta.

Method of Printing

The inks and ink sets of the present invention can be by printing with any inkjet printer. The substrate can be any suitable substrate including plain paper, such as common electrophotographic copier paper; treated paper, such as photo-quality inkjet paper; textile; and non-porous substrates including polymeric films such as polyvinyl chloride and polyester.

### EXAMPLES

Water was deionized unless otherwise stated. Ingredient amounts are in weight percent of the total weight of ink. Surfynol® 465 is a surfactant from Air Products (Allentown, Pa. USA).

The optical density values reported were measured with a Greytag Macbeth Spectrolino spectrometer and are an average of prints made on three different plain papers (HP office, Xerox 4024 and Hammermill Copy Plus) with a Canon i560 printer. The viscosities are rotational viscometry values at 25° C. measured by a Brookfield viscometer.

Dispersion 1

Carbon black (Nipex 180 from Degussa, surface area 150 m²/g) was oxidized with ozone according to the process described in previously incorporated U.S. Pat. No. 6,852,156. After recovery, a 12.8 weight percent dispersion of self-dispersing carbon black pigment in water was obtained with a viscosity of 3.5 cps (25° C.). The median particle size was about 98 nm. Potassium hydroxide was used to neutralize the treated pigment to a pH of 7.

The neutralized mixture was purified by ultra-filtration to remove free acids, salts and contaminants. The purification process was performed to repeatedly wash pigment with de-ionized water until the conductivity of the mixture leveled off and remained relatively constant.

Dispersion 2

Dispersion 2 was Cab-O-Jet® 300 (a self-dispersing carbon black pigment from Cabot Corporation) dispersed in water at about 15 weight percent concentration.

Dispersion 3

Dispersion 3 was a polymer stabilized carbon black dispersion prepared in a manner similar to example 3 in U.S. Pat. No. 5,519,085 (the disclosure of which is incorporated by reference herein for all purposes as if fully set forth) except that the dispersant was a block copolymer with methacrylic acid//benzyl methacrylate//ethyltriethyleneglycol methacrylate (13//15//4). The neutralizing agent was potassium hydroxide. The pigment content was adjusted to be 15% by weight. The dispersant had a number average molecular weight of about 5,000 and weight average molecular weight of about 6,000 g/mol, and was prepared in a manner similar to “preparation 4” described in previously incorporated U.S. Pat. No. 5,519,085, except the monomer levels were adjusted to give the ratio indicated.

Latency Test

Latency (decap time) was determined according to the following procedure using a Hewlett Packard 850 printer that was altered so that the ink cartridge would not be serviced during the test. Just prior to the beginning of the test, the nozzles were primed and a nozzle check pattern was performed to ensure all nozzles were firing acceptably. No further servicing was then conducted

During each scan across the page, the pen printed a pattern of 149 vertical lines spaced about 1/16 inch apart. Each vertical line was formed by all nozzles firing one drop, therefore the line was one drop wide and about ½ inch high corresponding to the length of the nozzle array on the printhead. The first vertical line in each scan was the first drop fired from each nozzle after the prescribed latency period, the fifth line was the fifth drop from each nozzle on that scan, and so forth for all 149 lines.

The pattern was repeated at increasingly longer time intervals (decap times) between scans. The standard time intervals between scans was 1, 2, 3, 4, 5, 6, 7, 8, 9, 10, 20, 30, 40, 50, 60, 70, 80, 90 100, 200, 300, 400, 500, 600, 700, 800, 900, and 1000 seconds. Nothing beyond 1000 seconds was attempted.

Upon completion of the test, the 1^{st}, 5^{th} and 32^{nd} vertical lines in each scan were examined for consistency, misdirected drop deposits and clarity of the print. These lines corresponded to the 1^{th}, 5^{th} and 32^{nd} drops of ink droplets ejected from the nozzle after a prescribed latency period. The decap time was the longest time interval where the particular vertical line could be printed without significant defects.

Preferably, the pen fires properly on the first drop. However, when the first drop fails to eject properly, the decap time for the fifth and thirty-second drops can provide some information as to the severity of the pluggage and how easily the nozzles can be recovered.

The results tables hereinafter report only the first drop decap time and refer to the value simply as the “Decap Time” in units of seconds.

Nozzle Strength Test

This test provides a simple way to evaluate how well the ink fires from the printhead and how well it primes the printhead nozzles.

The inks were filled into HP 45A cartridges and a nozzle check pattern was printed using an HP DeskJet 800 series printer. The nozzle check pattern consisted of a short line printed by each individual nozzle in the printhead. The pattern was evaluated for missing or misdirected lines indicating a problem with firing from a particular nozzle. The nozzle check patterns were rated according to the following criteria:
Good—2 or fewer missing or misdirected nozzles
Fair—2 to 5 missing or misdirected nozzles
Poor—More than 5 missing or misdirected nozzles

### Example 1

Inks were prepared by mixing together various humectant combinations, listed in the following table, with SDP dispersion (3.5% on a pigment basis) and 0.2% Surfynol® 465. The balance of the formulation was water. The SDP was Dispersion 1 for Inks 1a-1k and Dispersion 2 for Ink 1L. The first humectant was diethylene glycol (DEG), the second humectant was 2-pyrrolidone (2-P) and the third humectant was urea.

The results demonstrate the beneficial effects of the present invention. The proper combination of first, second and third humectants provided surprisingly good (long) decap while maintaining good jetting characteristics.

Ratios of humectants are preferably optimized for each ink and these ratios may be different depending on other ingredients present in the formulation. Optimization can be routinely accomplished by one of ordinary skill in the art.

| | | | | Total | Decap | Nozzle |
|---|---|---|---|---|---|---|
| Ink | DEG | 2-P | Urea | Humectant | time | Strength |
| Ink 1a | 5.0 | 5.0 | 5.0 | 15.0 | 200 | Good |
| Ink 1b | 5.0 | 5.0 | 10.0 | 20.0 | 80 | Good |
| Ink 1c | 6.0 | 3.0 | 6.0 | 15.0 | >1000 | Good |
| Ink 1d | 8.0 | 4.0 | 8.0 | 20.0 | >1000 | Fair |
| Ink 1e | 10.0 | 5.0 | 10.0 | 25.0 | 70 | Good |
| Ink 1f | 3.0 | 6.0 | 6.0 | 15.0 | 80 | Fair |
| Ink 1g | 4.0 | 8.0 | 8.0 | 20.0 | 60 | Fair |
| Ink 1h | 5.0 | 10.0 | 10.0 | 25.0 | 30 | Good |
| Ink 1i | 7.5 | 5.0 | 7.5 | 20.0 | 300 | Good |
| Ink 1j | 7.0 | 6.0 | 7.0 | 20.0 | 400 | Good |
| Ink 1k | 12.0 | 4.0 | 4.0 | 20.0 | >1000 | Good |
| Ink 1L | 8.0 | 4.0 | 8.0 | 20.0 | >1000 | Good |

### Example 2 (Comparative)

These comparative examples (Inks 2a-2g) show that inks with no humectant or with only individual or two-way combinations of first, second and third humectants do not achieve the overall performance of the inventive inks comprising all three prescribed humectants.

| | Ink | Ink | Ink | Ink | Ink | Ink | |
|---|---|---|---|---|---|---|---|
| Ingredient | 2a | 2b | 2c | 2d | 2e | 2f | Ink 2g |
| Dispersion 1 | 3.5 | 3.5 | 3.5 | 3.5 | 3.5 | 3.5 | 3.5 |
| (% pigment) | | | | | | | |
| Diethylene glycol | — | 20 | — | — | 5.0 | 7.0 | — |
| 2-Pyrrolidone | — | — | 20.0 | — | — | 10.0 | 10 |
| Urea | — | — | — | 15.0 | 10.0 | — | 10 |
| Surfynol ® 465 | 0.2 | 0.2 | 0.2 | 0.2 | 0.2 | 0.2 | 0.2 |
| Water (Balance to | Bal. | Bal. | Bal. | Bal. | Bal. | Bal. | Bal. |
| 100) | | | | | | | |
| Print Properties | | | | | | | |
| Decap Time (sec.) | 5 | 100 | 90 | 70 | 100 | 60 | 50 |
| Nozzle Strength | Poor | Poor | Good | Good | Fair | Poor | Poor |

### Example 3 (Comparative)

This example shows that when the SDP of inventive inks is replaced with conventional polymer stabilized pigment in comparative Ink 3a, the beneficial performance characteristics are lost—decap time is short and nozzle strength is poor.

| | Ink 3a |
|---|---|
| Ingredient | |
| Dispersion 3 (pigment) | 3.5 |
| Diethylene glycol | 8.0 |
| 2-Pyrrolidone | 4.0 |
| Urea | 8.0 |
| Surfynol ® 465 | 0.2 |
| Water (Balance to 100) | Bal. |
| Print Properties | |
| Decap Time (sec.) | 50 |
| Nozzle Strength | Poor |

### Example 4

This Example shows various polyhydroxy compounds—ethylene glycol, propylene glycol, triethylene glycol, glycerol, fructose and xylose—as the first humectant. Ink formulations and print properties are summarized in the following table.

| | Ink | Ink | Ink | | Ink | |
|---|---|---|---|---|---|---|
| Ingredient | 41 | 42 | 43 | Ink 44 | 45 | Ink 46 |
| Dispersion 1 | 3.5 | 3.5 | 3.5 | 3.5 | 3.5 | 3.5 |
| (% pigment) | | | | | | |
| Ethylene glycol | 8.0 | — | — | — | — | — |
| Propylene glycol | — | 8.0 | — | — | — | — |
| Triethylene glycol | — | — | 8.0 | — | — | — |
| Glycerol | — | — | — | 8.0 | — | — |
| Fructose | — | — | — | — | 8.0 | — |
| Xylose | — | — | — | — | — | 8.0 |
| 2-Pyrrolidone | 4.0 | 4.0 | 4.0 | 4.0 | 4.0 | 4.0 |
| Urea | 8.0 | 8.0 | 8.0 | 8.0 | 8.0 | 8.0 |
| Surfynol ® 465 | 0.2 | 0.2 | 0.2 | 0.2 | 0.2 | 0.2 |
| Water | Bal. | Bal. | Bal. | Bal. | Bal. | Bal. |
| (Balance to 100) | | | | | | |
| Print Properties | | | | | | |
| Decap Time (sec.) | 300 | 100 | 500 | >1,000 | 700 | >1,000 |
| Nozzle Strength | Good | Good | Good | Good | Good | Good |

### Example 5

This example demonstrates more polyhydroxy compounds as the first humectant, and some glycol ethers as comparative humectants.

| | | Ink 5b | | Ink 5d |
|---|---|---|---|---|
| | Ink 5a | (comp.) | Ink 5c | (comp.) |
| Ingredient | | | | |
| Dispersion 1 (% pigment) | 3.5 | 3.5 | | |
| 1,2,6-Hexanetriol | 8.0 | — | — | — |
| 1,5-Pentanediol | — | 8.0 | — | — |
| Trimethylolpropane | — | — | 8.0 | — |
| Diethylene glycol butyl ether | — | — | — | 8.0 |
| 2-Pyrrolidone | 4.0 | 4.0 | 4.0 | 4.0 |
| Urea | 8.0 | 8.0 | 8.0 | 8.0 |
| Surfynol ® 465 | 0.2 | 0.2 | 0.2 | 0.2 |
| Water (Balance to 100) | Bal. | Bal. | Bal. | Bal. |
| Print Properties | | | | |
| Decap Time (sec.) | 70 | 30 | 40 | 30 |
| Nozzle Strength | Good | Poor | Good | Poor |

### Example 6

This example demonstrates other compounds as the second humectant, namely sulfolane, tetramethylene sulfoxide, 1,3-dimethyl-2-imidazolidinone, and gamma-butyrolactone and bis-hydroxyethyl-5,5-dimethylhydantoin (DANTOCOL DHE from Lonza Inc., Allendale, N.J.)

| Ingredients | Ink 6a | Ink 6b | Ink 6c | Ink 6d | Ink 6e |
|---|---|---|---|---|---|
| Dispersion 1 | 3.5 | 3.5 | 3.5 | 3.5 | 3.5 |
| (wt % pigment) | | | | | |
| Diethylene glycol | 8.0 | 8.0 | 8.0 | 12.0 | 8.0 |
| Sulfolane | 4.0 | — | — | — | — |
| Tetramethylene | — | 4.0 | — | — | — |
| sulfoxide | | | | | |
| 1,3-dimethyl-2- | — | — | 4.0 | — | — |
| imidazolidinone | | | | | |
| Gamma- | — | — | — | 4.0 | — |
| butyrolactone | | | | | |
| DANTOCOL | — | — | — | — | 4.0 |
| DHE | | | | | |
| Urea | 8.0 | 8.0 | 8.0 | 4.0 | 8.0 |
| Surfynol ® 465 | 0.2 | 0.2 | 0.2 | 0.2 | 0.2 |
| Water | Bal. | Bal. | Bal. | Bal. | Bal. |
| (Balance to 100) | | | | | |
| Print Properties | | | | | |
| Decap Time | >1,000 | 600 | 400 | >1,000 | >1,000 |
| (sec.) | | | | | |
| Nozzle Strength | Good | Good | Good | Good | Good |

### Example 7

This example shows the effect of surfactant loading. Ink 7a comprises 1.0% Surfynol® 465 surfactant versus 0.2% in Ink 6a. With the increase in surfactant loading the decap time decreases to 100 seconds from more than 1,000 seconds for 6a.

| | Ink 7a |
|---|---|
| Ingredients | |
| Dispersion 1 (% pigment) | 3.5 |
| Diethylene glycol | 8.0 |
| Sulfolane | 4.0 |
| Urea | 8.0 |
| Surfynol 465 | 0.2 |
| Water | Balance to 100 |
| Print Properties | |
| Decap Time (sec.) | 100 |
| Nozzle Strength | Good |

1. An aqueous ink-jet ink comprising a colorant stably dispersed in an aqueous vehicle, wherein:
(a) said colorant comprises a self-dispersing pigment; and
(b) said aqueous vehicle comprises water, a first humectant, a second humectant and a third humectant wherein
(i) said first humectant is one or a combination of a water-soluble organic molecule having at least two hydroxyl groups, and a carbon/oxygen ratio of two or less;
ii) said second humectant is selected from the group consisting of 2-pyrrolidone, sulfolane, tetramethylene sulfoxide, gamma-butyrolactone, 1,3-dimethyl-2-imidazolidinone, and bis-hydroxyethyl-5,5-dimethylhydantoin and mixtures thereof; and
(iii) said third humectant is urea,
provided that the amount of sulfolane, if present, is less than 5% by weight based on the total weight of the ink.

2. The ink of claim 1, wherein the first humectant is selected from the group consisting of glycerol, ethylene glycol, diethylene glycol, triethylene glycol, tetraethylene glycol, propylene glycol, saccharides, saccharide derivatives and mixtures thereof.

3. The ink of claim 2, wherein the first humectant comprises at least one of diethylene glycol or glycerol.

4. The ink of claim 2, wherein the first humectant comprises at least one saccharide or saccharide derivative.

5. The ink of any of claims 1-5, wherein the second humectant comprises at least one of 2-pyrrolidone, sulfolane or gamma-butyrolactone.

6. The ink of any of claims 1-5, wherein:
(i) the self-dispersing pigment is present in an amount of from about 0.01 wt % to about 10 wt %;
(ii) the first humectant is present in an amount of from about 0.1 wt % to about 25 wt %;
(iii) the second humectant is present in an amount of from about 0.1 wt % to about 10 wt %; and
(iv) the third humectant is present in an amount of from about 0.1 wt % to about 15 wt %;
wherein wt % is based on the total weight of the ink.

7. The ink of claim 6, wherein:
(ii) the first humectant is present in an amount of from about 3 wt % to about 15 wt %;
(iii) the second humectant is present in an amount of from about 0.5 wt % to about 6 wt %; and
(iv) the third humectant is present in an amount of from about 2 wt % to about 8wt %.

8. The ink of any of claims 1-7, wherein the sum of the amounts of the first, second and third humectants present in the ink is from about 6 wt % to about 29 wt %, based on the total weight of ink.

9. The ink of any of claims 1-8, further comprising one or more surfactant(s).

10. The ink of claim 9, wherein the total amount of all surfactants present in the ink is from about 0.01 wt % to about 0.5 wt %, based on the total weight of the ink.

11. The ink of any of claims 1-10, wherein the self-dispersing pigment is a self-dispersing black pigment.

12. The ink of any of claims 1-11, wherein the viscosity at 25° C. is less than about 7 cps.

13. An inkjet ink set comprising at least two differently colored inks, wherein at least one of the inks is an inkjet ink as set forth in any one or combination of claims 1-12.

14. A method for inkjet printing onto a substrate, comprising the steps of:
(a) providing an inkjet printer that is responsive to digital data signals;
(b) loading the printer with a substrate to be printed;
(c) loading the printer with an ink as set forth in any one or combination of claims 1-12; and
(d) printing onto the substrate using the ink or inkjet ink set in response to the digital data signals.

15. The method of claim 14, wherein the printer is loaded with an inkjet ink set as set forth in claim 13.
